(19) United States
(12) Patent Application Publication
(10) Pub. No.: US 2022/0266942 A1
(43) Pub. Date: Aug. 25, 2022

(54) BAR HANDLE DEVICE

(71) Applicant: Honda Motor Co., Ltd., Tokyo (JP)

(72) Inventors: Zao shan CHONG, Saitama (JP); Hidetoshi Kimijima, Saitama (JP); Junji TAKADO, Saitama (JP)

(73) Assignee: Honda Motor Co., Ltd., Tokyo (JP)

(21) Appl. No.: 17/541,191

(22) Filed: Dec. 2, 2021

(30) Foreign Application Priority Data
Feb. 24, 2021 (JP) 2021-027579

(51) Int. Cl. B62K 21/12; B62K 21/18

(52) U.S. Cl. CPC B62K 21/12; B62K 21/18

(57) ABSTRACT

A bar handle device includes a fixing portion attached to a steering mechanism, a short portion to which grips are attached, and a long portion connecting the short portion and the fixing portion. The long portion is composed of a first bar member and a second bar member interconnected in serial, and includes a cross-linking member connecting the first bar member and the second bar member.

### CROSS-REFERENCE TO RELATED APPLICATION

This application claims the priority benefits of Japanese application no. 2021-027579, filed on Feb. 24, 2021. The entity of the above-mentioned patent application is incorporated by reference herein and made a part of the specification.

### BACKGROUND

### Technical Field

The disclosure relates to a bar handle device.

### Description of Related Art

In the past, bar handle devices have been proposed to be attached to the steering mechanism of the vehicles such as competition wheelchairs, skateboards, kickboards, jet skis, snowboards, and electrically powered motorcycles and bicycles, (see, for example, Patent Literature 1).

### RELATED ART

### Patent Literature

[Patent Literature 1] Japanese Unexamined Patent Publication No. 2000-289673

Conventional bar handle devices tend to start deteriorating from the starting point portion because stress is concentrated on the starting point portion, which is the center of rotation when the steering mechanism is steered.

It is desired that the bar handle device is made lighter to reduce the weight of the entire vehicle, but if the wall thickness of the handle is reduced, but the strength will decrease and deterioration is likely to occur. On the other hand, increasing the wall thickness around the starting point portion or assembling so as to wrap around the starting point portion not only hinders weight reduction but also impairs the aesthetics and assembly of the handle.

Therefore, an object of the disclosure is to realize weight reduction of the handle and to reduce stress concentration to enhance the robustness of the bar handle.

### SUMMARY

As an aspect of the disclosure, examples may be given such as: a bar handle device including a fixing portion attached to a steering mechanism; a short portion to which grips are attached; and a long portion connecting the short portion and the fixing portion; the long portion is composed of a first bar member and a second bar member interconnected in serial, and includes a cross-linking member connecting the first bar member and the second bar member.

Further, in the bar handle device, the first bar member may have a linear shape, and the second bar member may have a bow shape.

Further, in the bar handle device, the first bar member and the second bar member, with the short portion being steered, may apply a force in a rotational direction to the steering mechanism attached to the fixing portion.

Further, in the bar handle device, the cross-linking member may be connected at an angle of 45 to 135 degrees with respect to a horizontal direction of the long portion.

Further, in the bar handle device, the cross-linking member may be connected within a range of 85% from the fixing portion, with respect to a horizontal length of the long portion.

### BRIEF DESCRIPTION OF THE DRAWINGS

FIG. 1 is a perspective diagram showing a competition wheelchair.

FIG. 2 is a left side diagram showing the competition wheelchair.

FIG. 3 is a plan diagram showing the competition wheelchair.

FIG. 4 is a perspective diagram showing a front fork and its surroundings.

FIG. 5 is a perspective diagram showing a main handle.

FIG. 6 is a side diagram showing a main handle.

FIG. 7 is a perspective diagram showing a main handle as a comparative example.

FIG. 8 is a diagram showing a measurement result of the relationship between the safety factor of the main handle and the arrangement position of a cross-linking member.

FIG. 9 is a perspective diagram showing another form of the main handle.

FIG. 10 is a perspective diagram showing another form of the main handle.

FIG. 11 is a perspective diagram showing another embodiment of the main handle.

FIG. 12 is a perspective diagram showing another embodiment of the main handle.

### DESCRIPTION OF THE EMBODIMENTS

Hereinafter, the present embodiment will be described with reference to the diagrams. In the description, directions such as front/rear/left/right and up/down are the same as the directions with respect to the vehicle body unless otherwise specified. Further, the reference numerals FR shown in each diagram indicate the front of the vehicle body, the reference numerals UP indicate the upper part of vehicle body, and the reference numerals LH indicate the left side of the vehicle body.

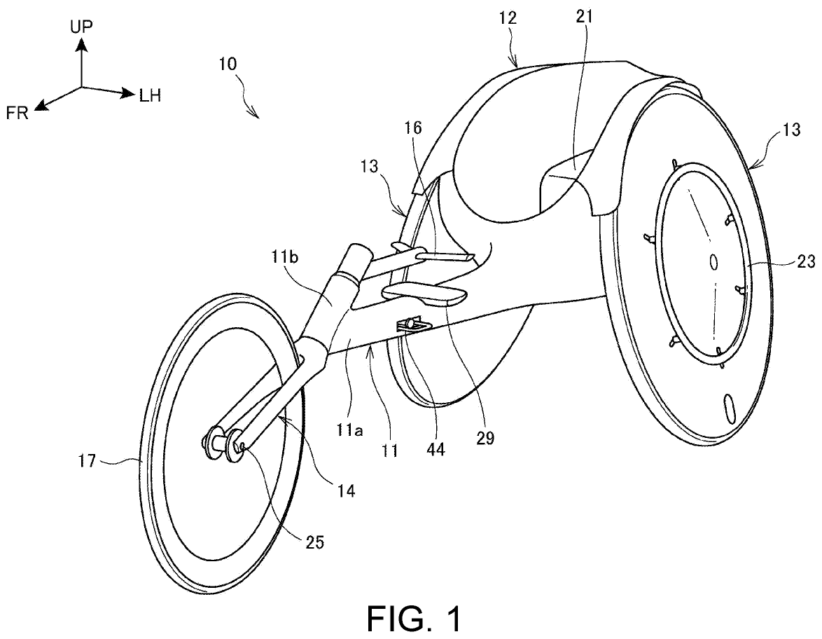

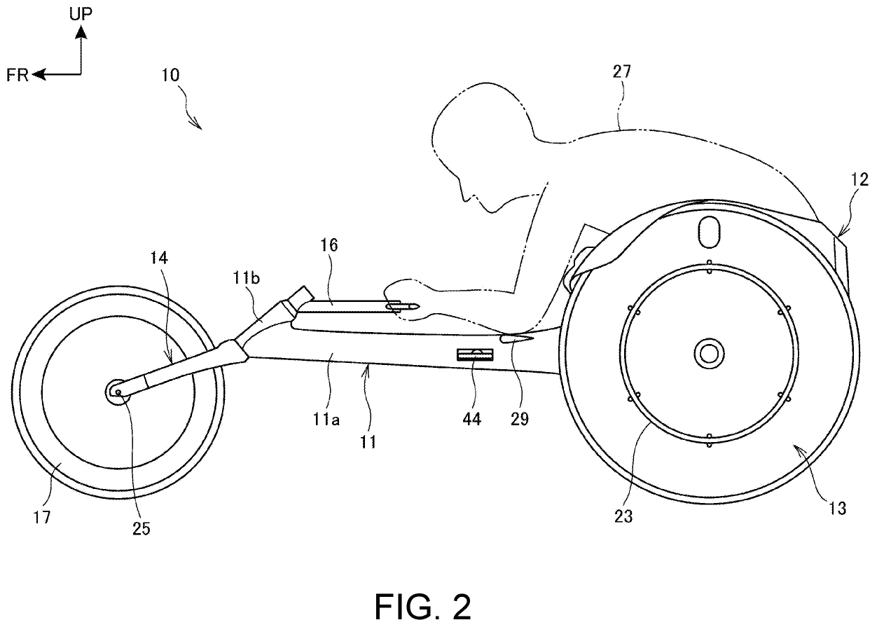

FIG. 1 is a perspective diagram showing a competition wheelchair 10. FIG. 2 is a left side diagram showing the competition wheelchair 10.

As shown in FIG. 1 and FIG. 2, the competition wheelchair 10 is used for track races, road races, and the like, and includes a vehicle body frame 11, a cage 12, a pair of left and right main wheels 13, a front fork 14, a main handle 16, and a front wheel 17.

The vehicle body frame 11 includes a hollow frame body 11a extending in a front-rear direction of the vehicle body and a head pipe 11b integrally provided at a front end portion of the frame body 11a, and is integrally provided with the cage 12 at a rear end portion of the frame body 11a.

The upper portion of the cage 12 is open, and a seat 21 on which the racer sits is provided inside the cage 12. The main wheels 13 are arranged on the left and right sides of the cage 12, and are rotatably supported by two side portions of the cage 12 by being tilted at a predetermined angle so that the upper end sides of the main wheels 13 tilt inward in the vehicle width direction with respect to the lower end sides. Attached to the left and right main wheels 13 are ring-shaped hand rims 23 that a racer 27 turns when applying driving force to the main wheels 13.

The front fork 14 is supported by the head pipe 11b so as to be steerable to the left and right, the main handle 16 is provided at the upper end of the front fork 14, and the front wheel 17 are rotatably supported at the lower end of the front fork 14 via an axle 25.

As shown in FIG. 2, the racer 27 sits on the seat 21 (see FIG. 1) of the cage 12 in a forward-leaning posture and holds the main handle 16 with both hands.

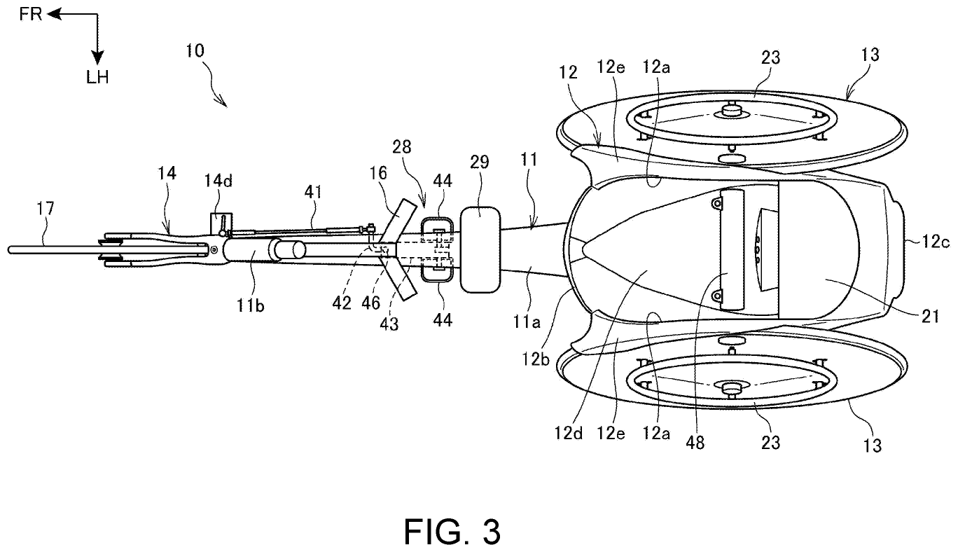

FIG. 3 is a plan diagram showing the competition wheelchair 10.

The vehicle body frame 11 is provided with a steering angle setting mechanism 28 that tilts the front wheel 17 to a preset steering angle by performing a pressing operation to maintain that state, and an elbow rest 29 arranged behind the steering angle setting mechanism 28.

The front fork 14 is integrally provided with an auxiliary handle 14d that projects laterally from one side portion (right side portion).

The steering angle setting mechanism 28 includes a damper link 41, a connecting arm 42, a track lever 43, and a pair of left and right pressing operation portions 44.

The auxiliary handle 14d is connected to the connecting arm 42 via the damper link 41. The damper link 41 is arranged on one side (right side) of the vehicle body frame 11, and two ends of the damper link 41 are swingably connected to the auxiliary handle 14d and the connecting arm 42.

The connecting arm 42 projects from the vehicle body frame 11 to one side (right side), and is connected to the track lever 43 extending in the front-rear direction inside the vehicle body frame 11.

The track lever 43 is supported by a swing shaft 46 provided on the vehicle body frame 11 side so as to swing left and right, and the pair of left and right pressing operation portions 44 are provided at the rear end portion of the track lever 43. The left and right pressing operation portions 44 project from the inside of the vehicle body frame 11 to the outside of the vehicle body frame 11 and can be pressed by the racer.

For example, when running on a track with the competition wheelchair 10, if one of the pressing operation portions 44 is pressed so that the track lever 43 extends in the front-rear direction, the state is maintained by a friction mechanism (not shown), and the steering angle of the front wheel 17 is set in the straight-ahead direction. Therefore, even when the racer releases his/her hand from the main handle 16, he/she can move along the straight course of the track. As a result, the racer can concentrate on turning the main wheels 13 while running along the straight course.

Further, when the pressing operation portions 44 on one side of the left and right side (for example, the left side) is pressed to swing the rear end side of the track lever 43 to the another side of the left and right side (the right side), the state is maintained by the friction mechanism (not shown). The swing of the track lever 43 is transmitted to the front fork 14 via the connecting arm 42, the damper link 41, and the auxiliary handle 14d, and the steering angle of the front wheel 17 is set to one side of the left and right side (left side). As a result, the racer can run along the corner of the track even when he/she releases his/her hand from the main handle 16, and the racer can concentrate on turning the main wheels 13 while running along the corner.

When the main handle 16 is operated, the damper link 41 expands and contracts when a load exceeding a predetermined load is applied in the axial direction, so that the front wheel 17 can be steered to the left and right via the front fork 14.

When the racer is in a forward-leaning position, both elbows of the racer can be placed on the elbow rest 29. The elbow rest 29 is streamlined in its cross-section (see FIG. 2).

The cage 12 is integrally formed from left and right side walls 12a, a front wall 12b, a rear wall 12c, and a bottom wall 12d, and a tubular member 48 extending in the vehicle width direction is attached to the left and right side walls 12a so as to penetrate therethrough. A wheel covering portion 12e is integrally formed on each upper edge of the left and right side walls 12a to cover the upper portions of the left and right main wheels 13 from above to prevent interference of the racer to the main wheels 13.

The tubular member 48 is supported at two sides by the axle (not shown) of the left and right main wheels 13. The seat 21 is arranged in the cage 12 behind the tubular member 48.

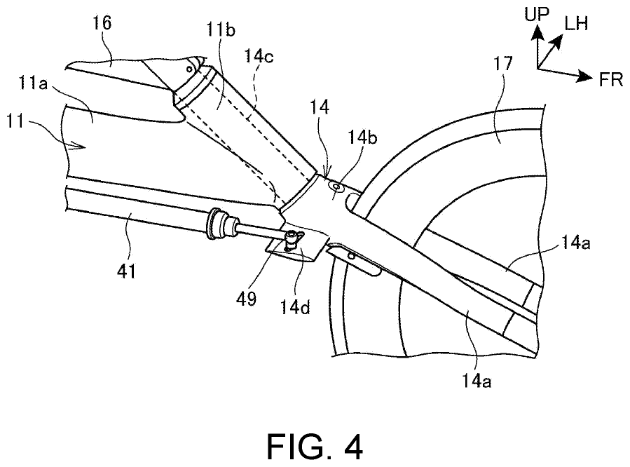

FIG. 4 is a perspective diagram showing the front fork 14 and its surroundings.

As shown in FIG. 4, the front fork (steering mechanism) 14 includes a pair of left and right fork legs 14a that support the front wheel 17, a bridge 14b that connects the fork legs 14a, and a fork stem 14c that extends diagonally upward and rearward from the bridge 14b.

The auxiliary handle 14d is integrally formed on one side (right side) of the bridge 14b to project outward in the vehicle width direction. The auxiliary handle 14d is formed flat up and down (specifically, streamlined in cross-section), and the front end of the damper link 41 is swingably connected to the auxiliary handle 14d via a universal joint 49.

The fork stem 14c is a portion rotatably supported by the head pipe 11b, and the main handle 16 is attached to the upper end portion of the fork stem 14c.

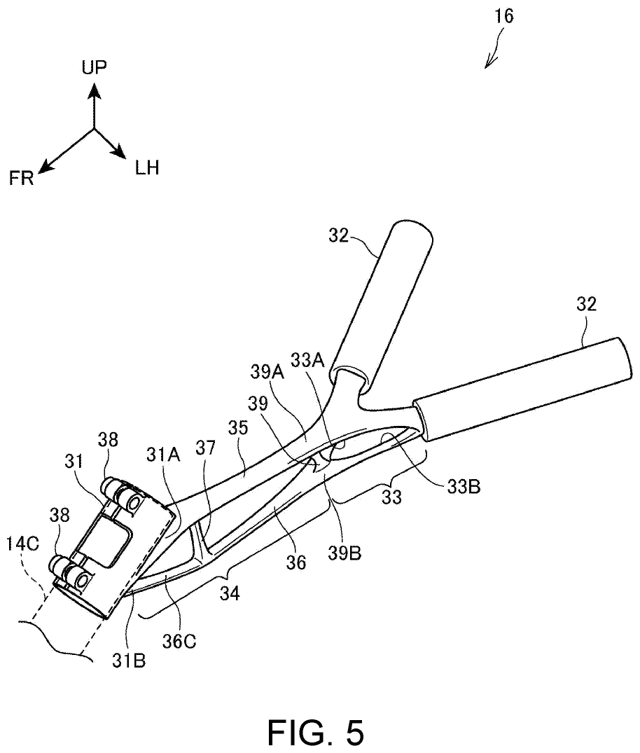

FIG. 5 is a perspective diagram showing the main handle 16.

The main handle 16 is a member corresponding to an example of the bar handle device. With the competition wheelchair 10, the racer 27 can operate the main handle 16 to turn the competition wheelchair 10 in a desired direction.

The main handle 16 is formed by a metal powder additive manufacturing method. Not limited to thereto, the main handle 16 may be formed by various processing methods and production methods such as casting, welding, and cutting.

As shown in FIG. 5, the main handle 16 includes a fixing portion 31 attached to the upper end portion of the fork stem 14c and a short portion 33 to which grips 32 are attached, wherein the short portion 33 and the fixing portion 31 are connected by a long portion 34.

The fixing portion 31 is a halved cylindrical body, and is fastened by bolts 38, with the upper end portion of the fork stem 14c sandwiched in between, to be attached to the upper end portion of the fork stem 14c.

The short portion 33 is Y-shaped when viewed from above, and the pair of grips 32 held by the racer are attached to the short portion 33.

An opening 33A is formed in the short portion 33 for weight reduction. The opening 33A is a through hole penetrating the main handle 16 in the width direction (left-right direction).

The short portion 33 includes a thin columnar end member 39 at the front end.

Further, an opening 33B is formed on the lower surface of the short portion 33 for weight reduction. The opening 33B communicates with the opening 33A.

The space formed in the short portion 33 by the opening 33A and the opening 33B functions as a lightening portion (hollow portion) of the main handle 16.

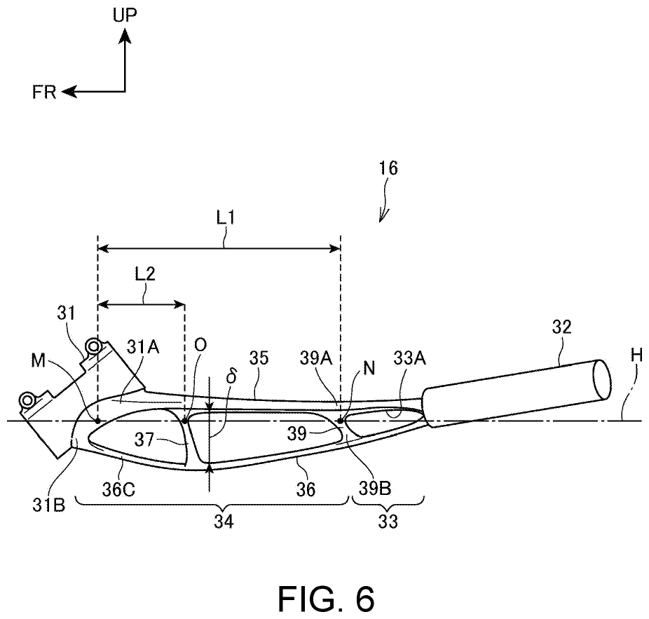

FIG. 6 is a side diagram showing the main handle 16.

As shown in FIG. 5 and FIG. 6, the long portion 34 is composed of a first bar member 35 and a second bar member 36 interconnected in serial. One end of the first bar member 35 is connected to an upper portion 31A of the fixing portion 31, and the other end is connected to an upper portion 39A of the end member 39 of the short portion 33.

The second bar member 36 is arranged below the first bar member 35 with an interval S. One end of the second bar member 36 is connected to a lower portion 31B of the fixing portion 31, and the other end is connected to a lower portion 39B of the end member 39 of the short portion 33.

The first bar member 35 and the second bar member 36 are connected by at least one cross-linking member 37. The cross-linking member 37 is a thin columnar member extending along the height direction (up-down direction) of the main handle 16.

Further, in the second bar member 36, the portion from the lower portion 31B to the position where the cross-linking member 37 is connected to the second bar member 36 is a stress dispersion portion 36C.

The first bar member 35 has a linear shape, and the second bar member 36 has a bow shape that is convex downward at the position of connection with the cross-linking member 37.

The first bar member 35 and the second bar member 36, with the grips 32 being held and the short portion 33 being steered, apply a force in the rotational direction to the front fork 14 attached to the fixing portion 31.

In FIG. 6, a horizontal line (horizontal direction of the long portion 34) H passes through a midpoint M between the upper portion 31A of the fixing portion 31 and the lower portion 31B of the fixing portion 31.

The cross-linking member 37 is connected at an angle of 45 to 135 degrees with respect to the horizontal line H.

Further, the cross-linking member 37 is connected to a position where a length dimension L2 falls within the range of 85% of a length dimension L1 from the fixing portion 31 side, with respect to the length dimension L1 of the long portion 34 in the horizontal direction.

As shown in FIG. 6, the length dimension L1 is a length dimension from the midpoint M to an intersection N, which is the point where the horizontal line H intersects the end member 39. The length dimension L2 is a length dimension from the midpoint M to an intersection O, which is the point where the horizontal line H intersects the cross-linking member 37.

Next, the operation of the present embodiment will be described.

With the competition wheelchair 10, the racer 27 can turn the competition wheelchair 10 in a desired direction by operating the main handle 16 with both hands.

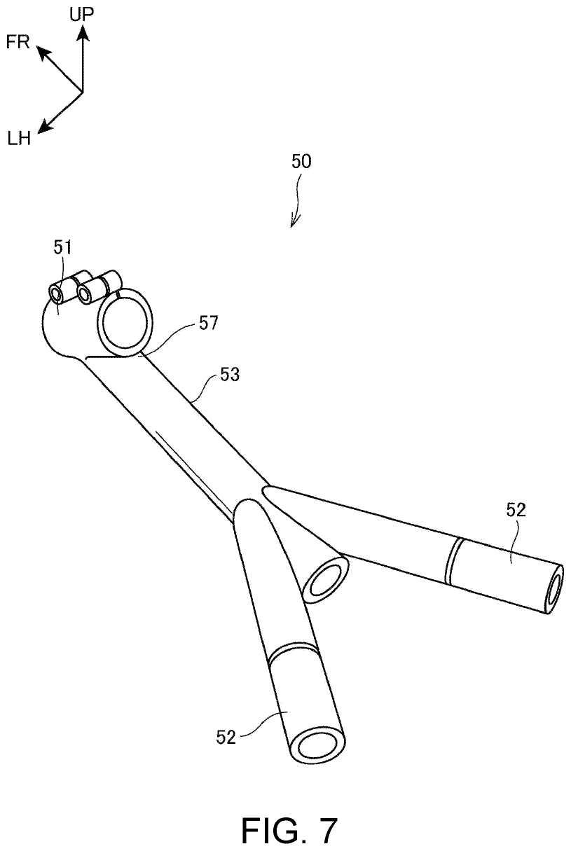

FIG. 7 is a perspective diagram showing a main handle 50 as a comparative example.

As shown in FIG. 7, the main handle 50 as a comparative example, similarly to the main handle 16, is provided with a fixing portion 51, which is attached to the upper end portion of the fork stem 14c (not shown), and grips 52.

Further, the main handle 50 includes a handle body 53 that connects the fixing portion 51 and the grips 52. The handle body 53 is formed in the shape of a solid rod having a predetermined length dimension.

A predetermined stress is applied to the main handle 50 as a comparative example being held and operated by the racer 27. In the main handle 50, a starting point portion 57 at the joint position of the fixing portion 51 and the upper surface side of the handle body 53 is most stressed during operation.

In the main handle 16 of the present embodiment, the first bar member 35 and the second bar member 36 of the long portion 34 are provided at locations corresponding to the handle body 53 of the main handle 50 as a comparative example.

As a result, the predetermined stress applied to the main handle 16 being held and operated by the racer 27 can be dispersed in the first bar member 35 and the second bar member 36, and the concentration of the stress can be suppressed.

Further, the main handle 16 includes the first bar member 35 and the second bar member 36, and the second bar member 36 is formed in a bow shape that is convex downward, therefore the stress dispersion portion 36C is likely to be the starting point of deformation when a stress of a predetermined value or more is applied.

That is, when a stress of a predetermined value or more is applied to the main handle 16, deformation that positively bends to the stress dispersion portion 36C occurs. As a result, it is possible to suppress the occurrence of destruction at each portion of the main handle 16.

Therefore, robustness in the main handle 16 can be improved.

Further, in the main handle 16, by providing the first bar member 35 and the second bar member 36 of the long portion 34, a space is provided between the first bar member 35 and the second bar member 36 of the long portion 34. The space functions as a lightening portion of the main handle 16. Therefore, robustness in the main handle 16 can be improved while reducing weight.

Next, an experiment conducted by the inventors to analyze the strength of the main handle 16 of the present embodiment will be described.

The inventors used a structural analysis by simulation using the main handle 16 of the present embodiment and the main handle 50 as a comparative example to verify the effect of the cross-linking member 37 on the performance of the main handle 16 of the present embodiment.

Specifically, the inventors arranged the cross-linking member 37 on the main handle 16 at different arrangement positions along the horizontal direction of the long portion 34 of the main handle 16, and measured the allowable stress of the main handle 16 in each case.

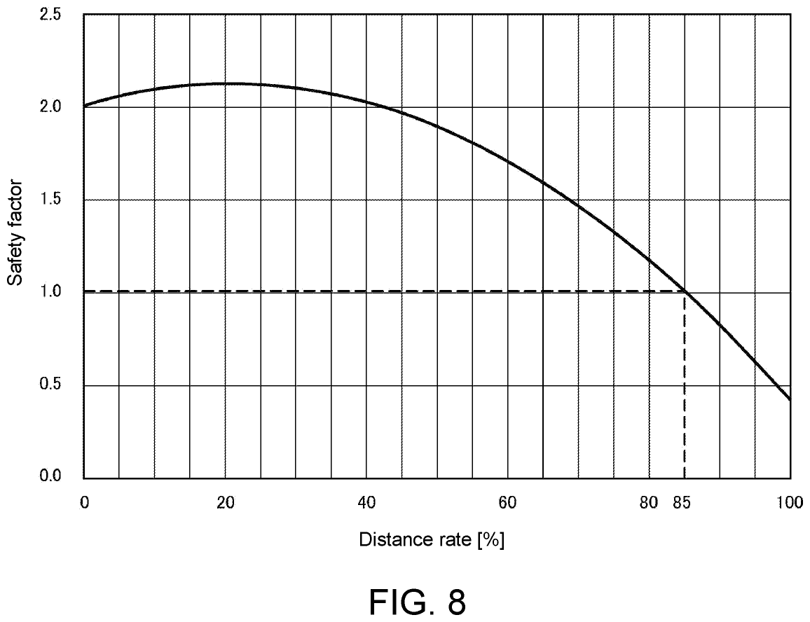

FIG. 8 is a diagram showing a measurement result of the relationship between the safety factor of the main handle 16 and the arrangement position of the cross-linking member 37. The vertical axis in FIG. 8 indicates the safety factor. The safety factor indicates the ratio of the allowable stress of the main handle 16 in each case where the cross-linking member 37 is arranged at different arrangement positions to the allowable stress of the main handle 50 as a comparative example. A safety factor of 1.0 on the vertical axis of FIG. 8 indicates that the main handle 16 has the same allowable stress as the main handle 50 as a comparative example. Further, the horizontal axis in FIG. 8 represents the distance ratio. The distance ratio indicates the ratio of the length dimension L2 from the fixing portion 31 side to the arrangement position of the cross-linking member 37 with respect to the length dimension L1 of the long portion 34 in the horizontal direction.

As shown in FIG. 8, the result shows that the main handle 16 has the maximum allowable stress when the cross-linking member 37 is connected to an arrangement portion having a length dimension L2 of about 20% of the length dimension L1 from the fixing portion 31 side, with respect to the length dimension L1 of the long portion 34 in the horizontal direction.

Further, the result shows that the main handle 16 has the same allowable stress as the allowable stress of the main handle 50 as a comparative example when the cross-linking member 37 is connected to an arrangement position having a length dimension L2 of about 85% of the length dimension L1 from the fixing portion 31 side, with respect to the length dimension L1 of the long portion 34 in the horizontal direction.

From the results, the inventors found that the main handle 16 can have a sufficient allowable stress when the cross-linking member 37 is connected at a position where the length dimension L2 falls within the range of 85% of the length dimension L1 from the fixing portion 31 side, with respect to the length dimension L1 of the long portion 34 in the horizontal direction.

Next, the inventors verified the influence of the angle formed by the longitudinal direction (up-down direction) of the cross-linking member 37 with respect to the horizontal direction of the long portion 34 on the performance of the strength of the main handle 16.

Specifically, the inventors arranged the cross-linking member 37 at different arrangement positions along the horizontal direction of the long portion 34 of the main handle 16, and measured the allowable stress of the main handle 16 in each case.

Specifically, the inventors arranged the cross-linking member 37 on the main handle 16 at different angles at which the cross-linking member 37 are formed with respect to the horizontal line H, and measured the allowable stress of the main handle 16 in each case.

The result shows that the main handle 16 has the maximum allowable stress when the cross-linking member 37 is connected to the long portion 34 at an angle of 90 degrees with respect to the horizontal line H.

Further, the result shows that the main handle 16 has the same allowable stress as the allowable stress of the main handle 50 as a comparative example when the cross-linking member 37 is connected to the long portion 34 at an angle of 45 to 135 degrees with respect to the horizontal line H.

From the results, the inventors found that the main handle 16 can have a sufficient allowable stress when the cross-linking member 37 is connected at an angle of 45 to 135 degrees with respect to the horizontal line H.

As described, according to the present embodiment, the main handle 16 includes the fixing portion 31 attached to the front fork 14, the short portion 33 to which grips are attached, and the long portion 34 connecting the short portion 33 and the fixing portion 31. The long portion 34 is composed of the first bar member 35 and the second bar member 36 interconnected in serial, and includes the cross-linking member 37 connecting the first bar member 35 and the second bar member 36.

Accordingly, with the main handle 16, by providing the first bar member 35 and the second bar member 36 and connecting the first bar member 35 and the second bar member 36 by the cross-linking member 37, the stress applied to the main handle 16 can be dispersed throughout the entire main handle 16. Therefore, in the main handle 16 destruction at a predetermined position can be suppressed.

Further, in the main handle 16 configured in this way, stress dispersion is realized. As a result, the main handle 16 can be formed with a thin wall thickness or the like or be formed with a lightening portion. Therefore, the weight of the main handle 16 can be reduced.

Further, according to the present embodiment, the first bar member 35 may have a linear shape, and the second bar member 36 may have a bow shape.

Accordingly, due to the bow shape, the second bar member 36 is deformed when a stress of a predetermined value or more is applied to the main handle 16, it is possible to prevent stress concentration on the main handle 16 and relieve the stress of the entire main handle 16.

Further, when a stress of a predetermined value or more is applied to the main handle 16, by visually recognizing the deformed state of the second bar member 36, it is possible to urge the racer 27 or a predetermined worker to replace the main handle 16 before the main handle 16 breaks.

Further, according to the present embodiment, the first bar member 35 and the second bar member 36, with the short portion 33 being steered, may apply a force in the rotational direction to the front fork 14 attached to the fixing portion 31.

Accordingly, the racer 27 can steer the competition wheelchair 10 by operating the main handle 16 provided with the first bar member 35 and the second bar member 36 by a normal steering wheel operation.

Further, according to the present embodiment, the cross-linking member 37 may be connected at an angle of 45 to 135 degrees with respect to the horizontal direction of the long portion 34.

Accordingly, the main handle 16 can have a sufficient allowable stress when the cross-linking member 37 is connected at an angle of 45 to 135 degrees with respect to the horizontal direction of the long portion 34.

Further, according to the present embodiment, the cross-linking member 37 may be connected within a range of 85% from the fixing portion, with respect to the horizontal length of the long portion 34.

Accordingly, the main handle 16 can have a sufficient allowable stress when the cross-linking member 37 is connected within a range of 85% from the fixing portion, with respect to the horizontal length of the long portion 34.

The above embodiment illustrates one aspect of the disclosure, and can be arbitrarily modified and applied without departing from the spirit of the disclosure.

In the above embodiment, the short portion 33 of the main handle 16 has a Y shape. However, the disclosure is not limited thereto; it may be T-shaped, for example.

Further, an opening may be formed on the upper surface of the short portion 33 for weight reduction.

Further, the short portion 33 may be solidly formed without the opening 33A and the opening 33B.

Further, for example, the first bar member 35 and the second bar member 36 may be connected by a plurality of cross-linking members 37.

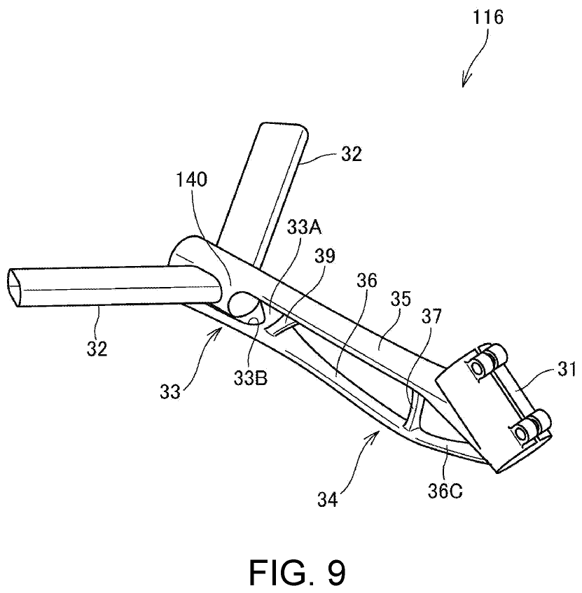

In the above embodiment, the short portion 33 of the main handle 16 is provided with a lightening portion made up by the opening 33A and the opening 33B. However, the disclosure is not limited thereto; as in a handle 116 shown in FIG. 9, a cylindrical portion 140 that guides the brake wire or the like may be provided in the lightening portion.

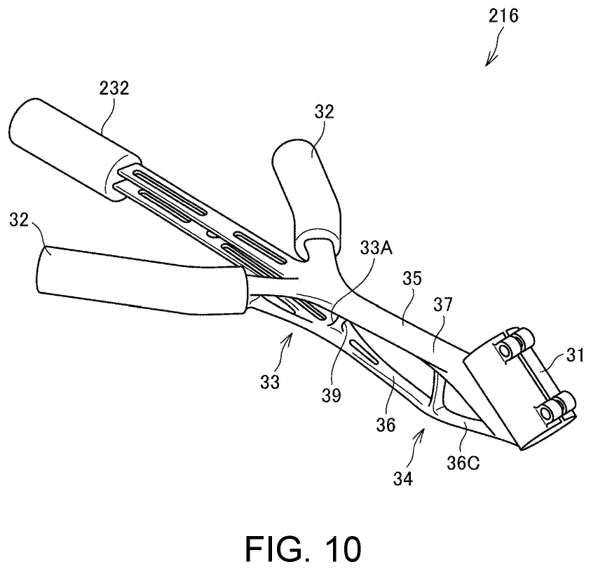

Further, for example, as in a main handle 216 shown in FIG. 10, the short portion 33 may be provided with a third handle 232 extending from between the two grips 32.

In the above embodiment, the main handle 16 is provided on the competition wheelchair 10, but the disclosure is not limited there; it may be used for various vehicles such as snow vehicles and all-terrain vehicles that use a T-shaped or Y-shaped handle.

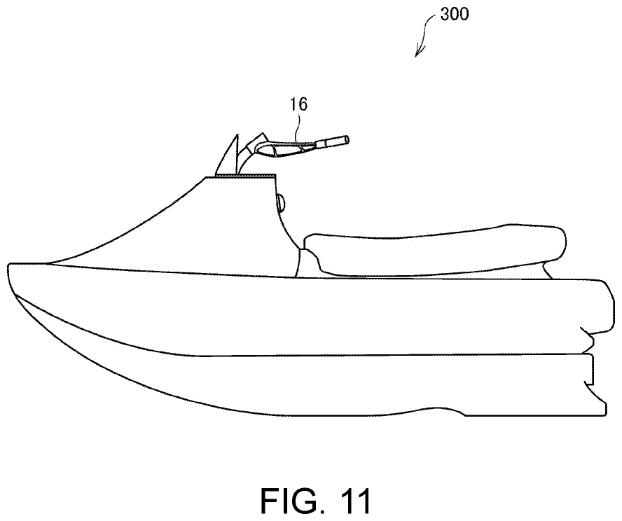

For example, as shown in FIG. 11, the main handle 16 may be used as a steering handle of a surface boat 300 such as a water bike.

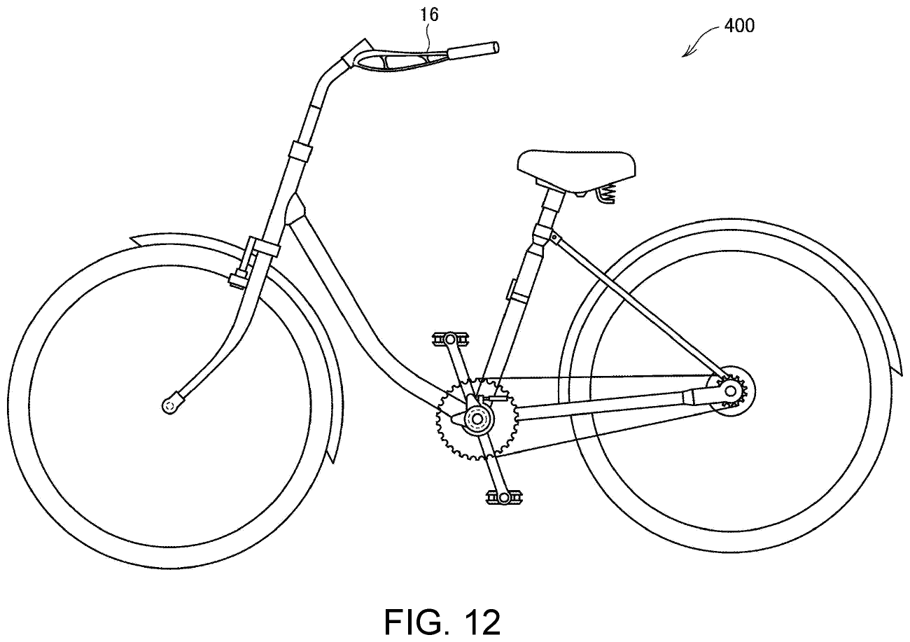

Further, for example, as shown in FIG. 12, the main handle 16 may be used as a handle of a bicycle 400.

According to the bar handle device, the weight of the handle can be reduced and the robustness of the bar handle can be enhanced by relieving stress concentration.

What is claimed is:

1. A bar handle device comprising:
a fixing portion attached to a steering mechanism, a short portion to which grips are attached, and a long portion connecting the short portion and the fixing portion,
wherein the long portion is composed of a first bar member and a second bar member interconnected in serial, and
comprises a cross-linking member connecting the first bar member and the second bar member.

2. The bar handle device according to claim 1,
wherein the first bar member has a linear shape, and the second bar member has a bow shape.

3. The bar handle device according to claim 1,
wherein the first bar member and the second bar member, with the short portion being steered, apply a force in a rotational direction to the steering mechanism attached to the fixing portion.

4. The bar handle device according to claim 2,
wherein the first bar member and the second bar member, with the short portion being steered, apply a force in a rotational direction to the steering mechanism attached to the fixing portion.

5. The bar handle device according to claim 1,
wherein the cross-linking member is connected at an angle of 45 to 135 degrees with respect to a horizontal direction of the long portion.

6. The bar handle device according to claim 2,
wherein the cross-linking member is connected at an angle of 45 to 135 degrees with respect to a horizontal direction of the long portion.

7. The bar handle device according to claim 3,
wherein the cross-linking member is connected at an angle of 45 to 135 degrees with respect to a horizontal direction of the long portion.

8. The bar handle device according to claim 4,
wherein the cross-linking member is connected at an angle of 45 to 135 degrees with respect to a horizontal direction of the long portion.

9. The bar handle device according to claim 1,
wherein the cross-linking member is connected within a range of 85% from the fixing portion, with respect to a horizontal length of the long portion.

10. The bar handle device according to claim 2,
wherein the cross-linking member is connected within a range of 85% from the fixing portion, with respect to a horizontal length of the long portion.

11. The bar handle device according to claim 3,
wherein the cross-linking member is connected within a range of 85% from the fixing portion, with respect to a horizontal length of the long portion.

12. The bar handle device according to claim 4,
wherein the cross-linking member is connected within a range of 85% from the fixing portion, with respect to a horizontal length of the long portion.

13. The bar handle device according to claim 5,
wherein the cross-linking member is connected within a range of 85% from the fixing portion, with respect to a horizontal length of the long portion.

14. The bar handle device according to claim 6,
wherein the cross-linking member is connected within a range of 85% from the fixing portion, with respect to a horizontal length of the long portion.

15. The bar handle device according to claim 7,
wherein the cross-linking member is connected within a range of 85% from the fixing portion, with respect to a horizontal length of the long portion.

16. The bar handle device according to claim 8,
wherein the cross-linking member is connected within a range of 85% from the fixing portion, with respect to a horizontal length of the long portion.
